(19) United States
(12) Patent Application Publication
(10) Pub. No.: US 2023/0196844 A1
(43) Pub. Date: Jun. 22, 2023

(54) TERMINAL DEVICE, METHOD, AND STORAGE MEDIUM

(71) Applicant: TOYOTA JIDOSHA KABUSHIKI KAISHA, Toyota-shi (JP)

(72) Inventor: Toshiki KASHIWAKURA, Tokyo (JP)

(21) Appl. No.: 18/047,693

(22) Filed: Oct. 19, 2022

(30) Foreign Application Priority Data
Dec. 22, 2021 (JP) 2021-208697

(51) Int. Cl. G07B 11/00; G06Q 10/02; G06Q 30/06; G06Q 50/30; H04W 4/40; H04W 4/80

(52) U.S. Cl. CPC G07B 11/00; G06Q 10/02; G06Q 30/0601; G06Q 50/30; H04W 4/40; H04W 4/80

(57) ABSTRACT

A terminal device according to the present disclosure is a terminal device including a control unit and a communication unit. The control unit is configured to receive identification information from a vehicle via short-range wireless communication through the communication unit, to acquire position information on the vehicle, and to perform processing for riding in the vehicle based on the identification information and position information on the vehicle. The identification information is information that can identify the vehicle.

### CROSS-REFERENCE TO RELATED APPLICATION

This application claims priority to Japanese Patent Application No. 2021-208697 filed on Dec. 22, 2021, incorporated herein by reference in its entirety.

### BACKGROUND

### 1. Technical Field

The present disclosure relates to a terminal device, a method, and a program.

### 2. Description of Related Art

Conventionally, a technique for managing an electronic ticket in a terminal device is known. For example, WO 2018/074504 discloses a technique in which the face of an electronic ticket is displayed on a terminal device and, after the electronic ticket is used, the face of the electronic ticket displayed on the terminal device is changed.

### SUMMARY

There is a need for further improving the usefulness of the technique for managing an electronic ticket in a terminal device.

In view of the foregoing, it is an object of the present disclosure to improve the usefulness of the technique for managing an electronic ticket in a terminal device.

A first aspect of the present disclosure relates to a terminal device including a control unit and a communication unit. The control unit is configured to receive identification information from a vehicle via short-range wireless communication through the communication unit, to acquire position information on the vehicle, and to perform processing for riding in the vehicle based on the identification information and the position information on the vehicle. The identification information is able to identify the vehicle.

A second aspect of the present disclosure relates to a method performed by a terminal device including a control unit and a communication unit. The method includes receiving identification information from a vehicle via short-range wireless communication through the communication unit, acquiring position information on the vehicle, and performing processing for riding in the vehicle based on the identification information and the position information on the vehicle. The identification information is able to identify the vehicle.

A third aspect of the present disclosure relates to a storage medium that stores a program causing a computer to perform receiving identification information from a vehicle via short-range wireless communication, acquiring position information on the vehicle, and performing processing for riding in the vehicle based on the identification information and the position information on the vehicle. The identification information is able to identify the vehicle.

According to one embodiment of the present disclosure, the usefulness of the technique for managing an electronic ticket in a terminal device is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a schematic configuration of a system according to one embodiment of the present disclosure;

FIG. 2 is a block diagram showing a schematic configuration of a vehicle;

FIG. 3 is a block diagram showing a schematic configuration of a server;

FIG. 4 is a block diagram showing a schematic configuration of a terminal device; and

FIG. 5 is a flowchart showing an operation example of the terminal device.

### DETAILED DESCRIPTION OF EMBODIMENTS

An embodiment of the present disclosure will be described below.

### Outline of Embodiment

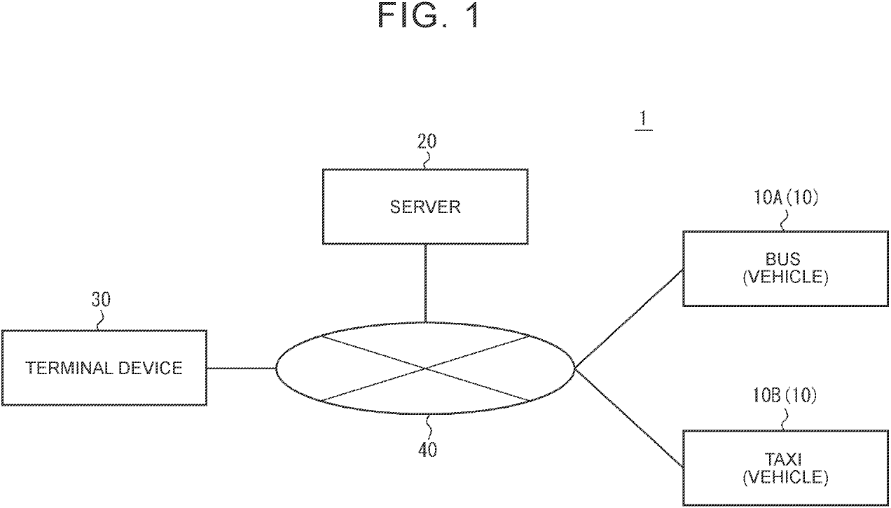

The outline of a system 1 according to one embodiment of the present disclosure will be described with reference to FIG. 1. FIG. 1 is a block diagram showing a schematic configuration of the system 1. The system 1 includes a bus 10A and a taxi 10B, a server 20, and a terminal device 30. In the description below, when the bus 10A and the taxi 10B are not particularly distinguished, they are collectively referred to as a vehicle 10.

The vehicle 10 includes, but is not limited to, the bus 10A and the taxi 10B. The vehicle 10 may be any vehicle that can be used for the purpose of the ride service for transporting users, such as shared cars, shared bicycles, trains, airplanes, helicopters, or drones. Note that the ride service may be paid or free of charge.

The server 20 is one computer or a plurality of computers capable of communicating with each other. The terminal device 30 is, but is not limited to, a smartphone. The terminal device 30 may also be any computer that the user can carry, such as a personal computer, a tablet terminal, or a mobile phone.

FIG. 1 shows two vehicles 10, one server 20, and one terminal device 30 for convenience of description. However, the system 1 may include any number of vehicles 10, servers 20, and terminal devices 30. The vehicle 10, server 20, and terminal device 30 are communicably connected to a network 40 including, for example, the Internet and a mobile communication network.

The outline of this embodiment will be described first, and the details will be described later. The system 1 is used, for example, as a usage management system that manages the ride service in which the vehicle 10 is used. The server 20, which is installed in the management center of a ride service provider, is used, for example, for the management of the user’s use status of the ride service, the delivery of an electronic ticket to the terminal device 30, or the management of an electronic ticket delivered to the terminal device 30. On the other hand, the user of the ride service carries the terminal device 30. When the user rides in the vehicle 10, the terminal device 30 receives the identification information, which can identify the vehicle 10, from the vehicle 10 via short-range wireless communication. In addition, the terminal device 30 acquires the position information on the vehicle 10 and, based on the identification information and the position information on the vehicle 10, performs the processing for riding in the vehicle 10. The processing for riding in the vehicle 10 includes the processing such as the acquisition of the user’s usage history of the vehicle 10, the confirmation of an electronic ticket, the usage-start processing, the display of the electronic-ticket purchase screen, and the purchase of an electronic ticket.

According to this embodiment, the user of the ride service only has to carry the terminal device 30, in which case, when the user rides in the vehicle 10, the terminal device 30 can perform the processing for riding in the vehicle 10. Therefore, the processing by the terminal device 30 for riding in the vehicle 10 leads to a reduction in the operation of the terminal device 30 required for the user, thus improving the usefulness of the technique for managing an electronic ticket on the terminal device 30.

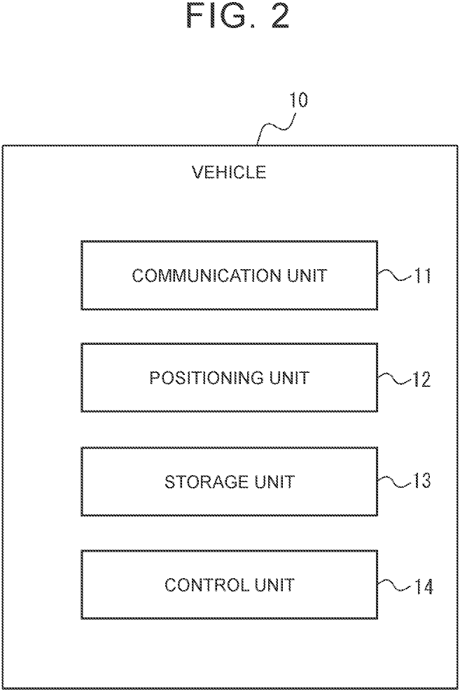

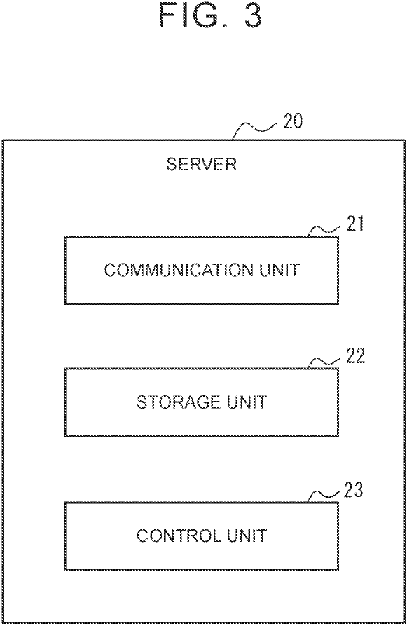

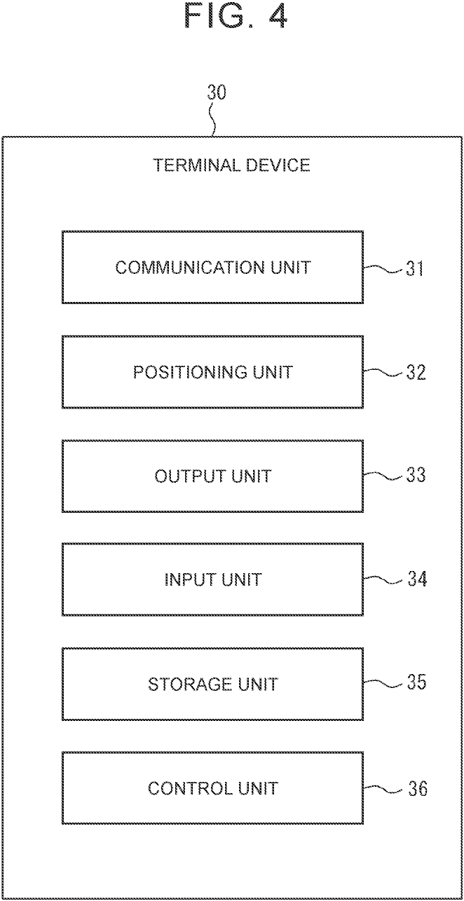

Next, the components of the system 1 will be described in detail below with reference to FIG. 2, FIG. 3 and FIG. 4. FIG. 2 is a block diagram showing a schematic configuration of the vehicle 10. FIG. 3 is a block diagram showing a schematic configuration of the server 20. FIG. 4 is a block diagram showing a schematic configuration of the terminal device 30.

### Configuration of Vehicle

As shown in FIG. 2, the vehicle 10 includes a communication unit 11, a positioning unit 12, a storage unit 13, and a control unit 14.

The communication unit 11 includes one or more communication interfaces for connection to the network 40. The communication interface included in the communication unit 11 supports a mobile communication standard such as the 4G (4th Generation) or 5G (5th Generation) communication standard. Note that the communication unit 11 may support not only those standards but also any communication standard. In this embodiment, the vehicle 10 communicates with the server 20 and the terminal device 30 via the communication unit 11 and the network 40. Note that, via the communication unit 11 and the network 40, the vehicle 10 may also communicate with a computer other than the server 20 and the terminal device 30 according to this embodiment.

The communication unit 11 includes one or more communication interfaces capable of short-range wireless communication. For example, the communication unit 11 may include a Bluetooth Low Energy (BLE) (registered trademark) beacon. However, the communication unit 11 may include not only a BLE beacon but also a communication interface that supports any short-range wireless communication standard such as Radio Frequency Identification (RFID), Near Field Communication (NFC), Ultra-High Frequency (UHF), Wi-Fi (registered trademark), Bluetooth (registered trademark), or infrared communication.

The positioning unit 12 includes one or more positioning devices that can measure the position of the vehicle 10 for acquiring the position information on the vehicle 10. The position information on the vehicle 10 is, for example, the two-dimensional coordinates or three-dimensional coordinates of the area where the vehicle 10 is located. The positioning unit 12 measures the position of the vehicle 10, for example, by navigation using a satellite positioning system or by autonomous navigation. To measure the position of the vehicle 10 by navigation using a satellite positioning system, the positioning unit 12 may include a receiver that supports the satellite positioning system. The satellite positioning system supported by the receiver may be, for example, Global Positioning System (GPS). The positioning unit 12 may include a sensor, such as an acceleration sensor or a gyro sensor, for measuring the position of the vehicle 10 by autonomous navigation.

The storage unit 13 includes one or more memories. The memory is, but not limited to, a semiconductor memory, a magnetic memory, or an optical memory. Each memory included in the storage unit 13 may function, for example, as a main storage device, an auxiliary storage device, or a cache memory. The storage unit 13 stores any information used for the operation of the vehicle 10. For example, the storage unit 13 may store programs such as system programs, application programs, and embedded software. The information stored in the storage unit 13 may be updatable, for example, with the information obtained from the network 40 via the communication unit 11.

The control unit 14 includes one or more processors, one or more programmable circuits, one or more dedicated circuits, or a combination thereof. The processor includes, but is not limited to, a general-purpose processor, such as a central processing unit (CPU) or a graphics processing unit (GPU), or a dedicated processor specialized for specific processing. The programmable circuit is, for example, a field-programmable gate array (FPGA), but is not limited thereto. The dedicated circuit is, for example, an application specific integrated circuit (ASIC), but is not limited thereto. The control unit 14 controls the overall operation of the vehicle 10.

The control unit 14 of the vehicle 10 sends the identification information, which can identify the vehicle 10, through the communication unit 11 via short-range wireless communication.

The identification information, which can identify the vehicle 10, may be the information that can identify any information about the vehicle 10, such as the control number, type, and route of the vehicle 10 or the information indicating whether the vehicle 10 supports an electronic ticket. For example, the identification information may also be a signal having a different wavelength, frequency, etc. depending on the vehicle 10. The identification information may also include, for example, a control number that can uniquely identify the vehicle 10.

The communication unit 11 may send the identification information, which can identify the vehicle 10, to an area within a predetermined distance from the communication unit 11. The communication unit 11 may adjust the type, or the output strength, of short-range wireless communication to change the predetermined distance. For example, when the vehicle 10 is a vehicle having a cabin such as the bus 10A and the taxi 10B, the communication unit 11 may be configured to send the identification information, which can identify the vehicle 10, to the cabin of the vehicle 10. This configuration can reduce the probability that, when the identification information on the vehicle 10 is accidentally received via short-range wireless communication, the terminal device 30 mistakenly recognizes that the user has ridden in the vehicle 10.

The communication unit 11 may send the identification information, which can identify the vehicle 10, continuously and repeatedly at predetermined intervals. Continuous and repeated sending of the identification information allows the terminal device 30 to more accurately receive the identification information on the vehicle 10 via short-range wireless communication.

Note that the information sent from the communication unit 11 of the vehicle 10 via short-range wireless communication is not limited to the identification information that can identify the vehicle 10. For example, the control unit 14 may further send the position information on the vehicle 10 via short-range wireless communication through the communication unit 11. The control unit 14 acquires the position information on the vehicle 10 by the positioning unit 12, and sends the position information on the vehicle 10 via short-range wireless communication through the communication unit 11. The control unit 14 may send the position information on the vehicle 10 and the identification information via short-range wireless communication at the same time or separately.

### Configuration of Server

As shown in FIG. 3, the server 20 includes a communication unit 21, a storage unit 22, and a control unit 23.

The communication unit 21 includes one or more communication interfaces for connection to the network 40. The communication interface included in the communication unit 21 supports a mobile communication standard, a wired local area network (LAN) standard, or a wireless LAN standard. Note that the communication unit 21 may support not only those standards but also any communication standard. In this embodiment, the server 20 communicates with the vehicle 10 and the terminal device 30 via the communication unit 21 and the network 40. Note that, via the communication unit 21 and the network 40, the server 20 may also communicate with a computer other than the vehicle 10 and the terminal device 30 according to this embodiment.

The storage unit 22 includes one or more memories. Each memory included in the storage unit 22 may function, for example, as a main storage device, an auxiliary storage device, or a cache memory. The storage unit 22 stores any information used for the operation of the server 20. For example, the storage unit 22 may store system programs, application programs, databases, and map information. The information stored in the storage unit 22 may be updatable, for example, with the information obtained from the network 40 via the communication unit 21.

The control unit 23 includes one or more processors, one or more programmable circuits, one or more dedicated circuits, or a combination thereof. The processor includes, but is not limited to, a general-purpose processor, such as a CPU or GPU, or a dedicated processor specialized for specific processing. The programmable circuit is, for example, an FPGA, but is not limited thereto. The dedicated circuit is, for example, an ASIC, but is not limited thereto. The control unit 23 controls the overall operation of the server 20.

### Configuration of Terminal Device

As shown in FIG. 4, the terminal device 30 includes a communication unit 31, a positioning unit 32, an output unit 33, an input unit 34, a storage unit 35, and a control unit 36.

The communication unit 31 includes one or more communication interfaces for connection to the network 40. The communication interface included in the communication unit 31 supports a mobile communication standard such as 4G or 5G communication standard. Note that the communication unit 31 may support not only those standards but also any communication standard. In this embodiment, the terminal device 30 communicates with the vehicle 10 and the server 20 via the communication unit 31 and the network 40. Note that, via the communication unit 31 and the network 40, the terminal device 30 may communicate with a computer other than the vehicle 10 and the server 20 according to the embodiment.

The communication unit 31 includes one or more communication interfaces capable of short-range wireless communication. The communication unit 31 may include a communication interface that supports any short-range wireless communication standard such as BLE, RFID, NFC, UHF, Wi-Fi, Bluetooth, or infrared communication.

The positioning unit 32 includes one or more positioning devices that can measure the position of the terminal device 30 for acquiring the position information on the terminal device 30. The position information on the terminal device 30 is, for example, the two-dimensional coordinates or three-dimensional coordinates of the area where the terminal device 30 is located. The positioning unit 32 measures the position of the terminal device 30, for example, by navigation using a satellite positioning system or autonomous navigation. To measure the position of the terminal device 30 by navigation using a satellite positioning system, the positioning unit 32 may include a receiver that supports the satellite positioning system. The satellite positioning system supported by the receiver may be, for example, GPS. The positioning unit 32 may include a sensor, such as an acceleration sensor or a gyro sensor, for measuring the position of the terminal device 30 by autonomous navigation.

The output unit 33 includes one or more output devices. The output devices included in the output unit 33 are, for example, a display, a speaker, and a vibrator. The output unit 33 outputs an image, sound, vibration, etc.

The input unit 34 includes one input device. The input device included in the input unit 34 is, for example, a touch panel, a camera, a microphone, and an IC card reader. The input unit 34 accepts input operations by the user. The output unit 33 and the input unit 34 may be configured as one device such as a touch panel.

The storage unit 35 includes one or more memories. Each memory included in the storage unit 35 may function, for example, as a main storage device, an auxiliary storage device, or a cache memory. The storage unit 35 stores any information used for the operation of the terminal device 30. For example, the storage unit 35 may store programs such as system programs, application programs, and embedded software. The information stored in the storage unit 35 may be updatable, for example, with the information obtained from the network 40 via the communication unit 31.

The control unit 36 includes one or more processors, one or more programmable circuits, one or more dedicated circuits, or a combination thereof. The processor includes, but is not limited to, a general-purpose processor, such as a CPU or GPU, or a dedicated processor specialized for specific processing. The programmable circuit is, for example, FPGA, but is not limited thereto. The dedicated circuit is, for example, an ASIC, but is not limited thereto. The control unit 36 controls the overall operation of the terminal device 30.

### Operation Flow of Terminal Device

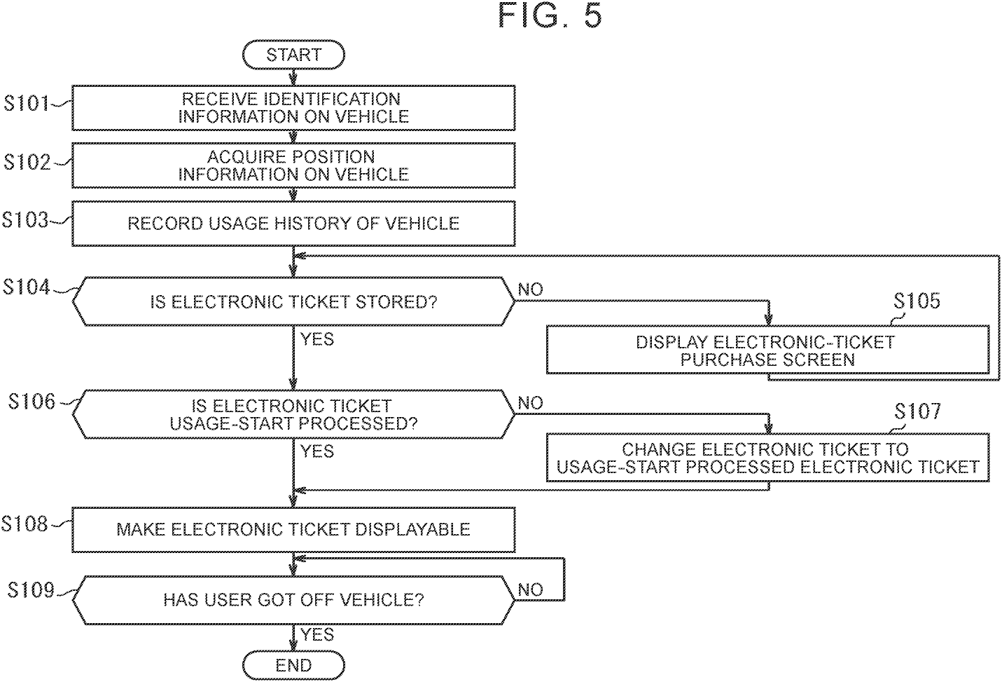

The operation of the terminal device 30 in the system 1 according to this embodiment will be described with reference to FIG. 5. FIG. 5 is a flowchart showing an operation example of the terminal device 30. This operation corresponds to the method performed by the terminal device 30 according to this embodiment.

Step S101: The control unit 36 of the terminal device 30 receives the identification information, which can identify the vehicle 10, from the vehicle 10 via short-range wireless communication through the communication unit 31.

Based on the identification information received from the vehicle 10, the control unit 36 identifies the vehicle 10. To identify the vehicle 10, any method may be used. For example, the control unit 36 may store the correspondence information between the vehicle 10 and the identification information in the storage unit 35 in advance. Using this correspondence information, the control unit 36 identifies the vehicle 10 based on the identification information and, then, identifies the information such as the type of the vehicle 10, the operation route, or the electronic ticket with which the user can ride. When the identification information on the vehicle 10 is received via short-range wireless communication, the control unit 36 may determine that the user who carries the terminal device 30 has ridden in the vehicle 10, that is, the user has ridden in the vehicle 10.

When the identification information on the vehicle 10 is continuously received, the control unit 36 may determine that the user has ridden in the vehicle 10. For example, in the case when the identification information is repeatedly sent from the vehicle 10 at predetermined intervals in the same manner as the BLE beacon, the control unit 36 may determine that the user has ridden in the vehicle 10 when the identification information is continuously received for a predetermined number of times (multiple times) or for a predetermined period of time. This can reduce the probability that, when the identification information on the vehicle 10 is accidentally received via short-range wireless communication, the terminal device 30 will mistakenly recognize that the user has ridden in the vehicle 10. However, when the identification information on the vehicle 10 is received once, the control unit 36 may also determine that the user has ridden in the vehicle 10.

Step S102: The control unit 36 of the terminal device 30 acquires the position information on the vehicle 10.

To acquire the position information on the vehicle 10, any method may be used. For example, the control unit 36 may use the positioning unit 32 to acquire the position information on the terminal device 30 itself and then determine the acquired position information on the terminal device 30 itself as the position information on the vehicle 10. Alternatively, the control unit 36 may receive the position information on the vehicle 10 from the vehicle 10 via short-range wireless communication through the communication unit 31. This method eliminates the need for the terminal device 30 to have the positioning unit 32, making it easy for the user to use an electronic ticket on the terminal device 30.

The control unit 36 of the terminal device 30 performs the processing for riding in the vehicle 10 based on the identification information and the position information on the vehicle 10.

Step S103: The control unit 36 of the terminal device 30 records the usage history of the vehicle 10.

The control unit 36 may store the identification information and the position information on the vehicle 10 in the storage unit 35 as the user’s usage history of the vehicle 10. This allows the control unit 36 to store the usage history of the vehicle 10, such as the information indicating in which vehicle 10 the user has ridden or the information indicating where the user has ridden in the vehicle 10. Therefore, the usefulness of the technique for managing electronic tickets on the terminal device 30 is improved.

In addition to the identification information and the position information on the vehicle 10, the control unit 36 may store the information, such as the electronic ticket number, the stop information, and the riding-in/getting-off status, in the storage unit 35 as the user’s usage history of the vehicle 10. In addition, the control unit 36 may send the usage history of the vehicle 10 to the server 20 via the communication unit 31 and the network 40. Sending the usage history of the vehicle 10 in this way allows the server 20 to use the user’s usage history of the vehicle 10 for managing the usage status of the ride service, for fare charging, or for detecting falsification or unauthorized use.

Note that the processing for riding in the vehicle 10 is not limited to the acquisition of the usage history. The processing for riding in the vehicle 10 may include at least one of the riding-in processing performed when riding in the vehicle 10, the processing performed while riding in the vehicle 10, or the getting-off processing performed when getting off the vehicle 10. The processing for riding in the vehicle 10 may include the confirmation of an electronic ticket, the usage-start processing, the display of the electronic-ticket purchase screen, and the purchase of an electronic ticket.

Step S104: The control unit 36 of the terminal device 30 determines whether the electronic ticket for riding in the vehicle 10 is stored in the storage unit 35.

Any method may be used to determine whether the electronic ticket is stored in the storage unit 35. For example, the electronic ticket may be associated with the information on a plurality of target vehicles in which the user can ride with the electronic ticket. When it is found, based on the identification information on the vehicle 10, that the vehicle 10 is included in the target vehicles associated with the electronic ticket, the control unit 36 determines that an electronic ticket for riding in the vehicle 10 is stored in the storage unit 35. This determination allows the terminal device 30 to manage a ride in two or more vehicles 10 such as the bus 10A and the taxi 10B. Therefore, when moving by connecting a plurality of vehicles 10, the user of the terminal device 30 can use the terminal device 30, for example, to move to point A by bus 10A first, then to move from point A to point B by taxi 10B, and so on.

In addition, the electronic ticket may be associated with the information on a geographical range in which the user can ride in the vehicle 10 with the electronic ticket. When it is found, based on the position information on the vehicle 10, that the position information on the vehicle 10 is included in the geographical range in which the user can ride in the vehicle 10, the control unit 36 determines that an electronic ticket for riding in the vehicle 10 is stored in the storage unit 35. This determination allows the terminal device 30 to manage the electronic ticket as an unlimited ride ticket with which the user can ride in the target vehicle within the predetermined expiration date and in the predetermined geographical range. Note that the electronic ticket may also be a ticket with which the user can ride in the target vehicle within the number of times determined in advance at the time of purchase or within the charged amount.

Step S105: When it is determined that the electronic ticket for riding in the vehicle 10 is not stored in the storage unit 35 (S104 - NO), the control unit 36 of the terminal device 30 displays the electronic-ticket purchase screen via the output unit 33.

Displaying the purchase screen in this way allows the user of the terminal device 30 to immediately purchase an electronic ticket even if the user does not have an electronic ticket for riding in the vehicle 10. This improves the ease of use of an electronic ticket on the terminal device 30. Note that, when it is determined that the electronic ticket is not stored in the storage unit 35, the control unit 36 may output, via the output unit 33, an image, a sound, a vibration, etc. instead of, or in addition to, displaying the electronic-ticket purchase screen to inform that the user has not an electronic ticket for riding in the vehicle 10. When the processing for purchasing the electronic ticket is normally performed after step S105, the control unit 36 performs the processing in step S104 again.

Step S106: When it is determined that the electronic ticket is stored in the storage unit 35 (S104 - YES), the control unit 36 of the terminal device 30 determines whether the electronic ticket is usage-start processed.

In this embodiment, the electronic ticket stored in the storage unit 35 of the terminal device 30 is an electronic ticket that has its state changed to the usable state by performing the electronic-ticket usage-start processing that involves communication with the server 20. When the electronic-ticket usage-start processing is performed for an electronic ticket, the control unit 36 may store, in association with the electronic ticket stored in the storage unit 35, the information indicating that the electronic ticket is usage-start processed. This information, once stored, allows the server 20 to recognize the usage status of the electronic ticket on the terminal device 30 and, at the same time, to prevent the falsification or unauthorized use of the electronic ticket on the terminal device 30. In the present disclosure, “an electronic ticket is usage-start processed” means that the electronic-ticket usage-start processing that involves communication with the server 20 has been normally performed on the terminal device 30. Note that, however, the electronic ticket may be an electronic ticket that does not require the electronic-ticket usage-start processing that involves communication with the server 20.

Step S107: When it is determined that the electronic ticket is not usage-start processed (S106 - NO), the control unit 36 of the terminal device 30 performs the usage-start processing that involves communication with the server 20 as described above to change the electronic ticket to a usage-start processed electronic ticket.

The control unit 36 of the terminal device 30 may perform the usage-start processing for the electronic ticket to start managing the expiration date of the electronic ticket. More specifically, the control unit 36 may perform the usage-start processing for the electronic ticket to store, in the storage unit 35 and in association with the electronic ticket, the information indicating that the electronic ticket is usage-start processed as well as the information such as the usage start time or usage end date of the electronic ticket. When the usage-start processing for the electronic ticket is normally performed, the control unit 36 performs the processing in step S108.

Step S108: When it is determined that the electronic ticket for riding in the vehicle 10 is usage-start processed (S106 - YES), the control unit 36 of the terminal device 30 makes the electronic ticket displayable via the output unit 33.

For example, the control unit 36 may display the usage-start processed electronic ticket on the display. Then, the user of the terminal device 30 can confirm the electronic ticket or present the electronic ticket to the driver of the vehicle 10. This improves the ease of use of the electronic ticket on the terminal device 30. Note that, when it is determined that the electronic ticket is usage-start processed, the control unit 36 may output an image, a sound, or a vibration, which informs that the user has an electronic ticket for riding in the vehicle 10, via the output unit 33 instead of, or in addition to, making the electronic ticket displayable.

Step S109: The control unit 36 of the terminal device 30 determines whether the user has got off the vehicle 10.

Any method may be used to determine whether the user has got off the vehicle 10. For example, when the identification information on the vehicle 10 is continuously received and, after that, the reception of the identification information is ended, the control unit 36 may determine that the user has got off the vehicle 10. More specifically, when the riding information is not continuously received for a predetermined period, the control unit 36 determines that the reception of the identification information is ended.

When it is determined that the user has not got off the vehicle 10 (step S109 - NO), the control unit 36 of the terminal device 30 determines that the user of the terminal device 30 is still in the vehicle 10 and repeats the processing in step S109. Each time the processing in step S109 is repeated, the control unit 36 may acquire the identification information and the position information on the vehicle 10 again and store the acquired information in the storage unit 35 as the user’s usage history of the vehicle 10. By doing so, the control unit 36 can store the travel route of the vehicle 10 as the user’s usage history of the vehicle 10. The control unit 36 may send the travel route of the vehicle 10 to the server 20 via the communication unit 31 and the network 40.

When it is determined that the user has got off the vehicle 10 (step S109 -YES), the control unit 36 of the terminal device 30 performs the getting-off processing, which is performed when the user gets off the vehicle 10, and then ends the operation.

For example, the getting-off processing includes the acquisition of the user’s usage history of the vehicle 10. The control unit 36 may acquire the identification information and the position information on the vehicle 10 again and then store the acquired information in the storage unit 35 as the user’s usage history of the vehicle 10. By doing so, the control unit 36 can store the position of getting-off the vehicle 10 as the user’s usage history of the vehicle 10. The control unit 36 may send the getting-off position of the vehicle 10 to the server 20 via the communication unit 31 and the network 40.

This allows the server 20 to determine whether the user has properly used the electronic ticket, based on the information on the getting-off position of the vehicle 10. Alternatively, based on the information on the riding-in position and the getting-off position of the vehicle 10, the server 20 may calculate the usage fare and subtract the calculated usage fare from the amount charged in the electronic ticket in the terminal device 30.

As described above, when the user of the ride service using the vehicle 10 rides in the vehicle 10, the terminal device 30 in this embodiment receives the identification information, which can identify the vehicle 10, from the vehicle 10 via short-range wireless communication. In addition, the terminal device 30 acquires the position information on the vehicle 10 and performs the processing for riding in the vehicle 10 based on the identification information and the position information on the vehicle 10.

This configuration allows the terminal device 30 to perform the processing for riding in the vehicle 10 by simply requiring a ride service user to carry the terminal device 30 when the user uses the vehicle 10. Therefore, the usefulness of the technique for managing an electronic ticket on the terminal device 30 is improved in that the operation on the terminal device 30, required for the user when performing processing on the terminal device 30 for riding in the vehicle 10, can be reduced.

Although the present disclosure has been described with reference to the drawings and embodiments, it should be noted that those skilled in the art can make various changes and modifications based on the present disclosure. Therefore, it is to be noted that these changes and modifications are within the scope of the present disclosure. For example, it is possible to relocate the functions included in each unit or each step in such a way that they are not logically contradictory, and it is possible to combine a plurality of units or steps into one or to divide them.

For example, it is also possible to provide an embodiment that causes a general-purpose computer to function as the terminal device 30 according to the embodiment described above. More specifically, a program describing the processing content that implements each function of the terminal device 30 according to the above-mentioned embodiment is stored in the memory of the general-purpose computer so that the processor can read the program for execution. Therefore, the present disclosure can also be implemented as a program that can be executed by a processor or as a non-transitory computer-readable medium (storage medium) that stores the program.

What is claimed is:

1. A terminal device comprising:
a control unit; and
a communication unit, wherein
the control unit is configured
to receive identification information from a vehicle via short-range wireless communication through the communication unit, the identification information being able to identify the vehicle,
to acquire position information on the vehicle, and
to perform processing for riding in the vehicle based on the identification information and the position information on the vehicle.

2. The terminal device according to claim 1, wherein the control unit is configured to determine that a user has ridden in the vehicle when the identification information on the vehicle is continuously received.

3. The terminal device according to claim 1, wherein the control unit is configured to receive the position information on the vehicle from the vehicle via the short-range wireless communication through the communication unit.

4. The terminal device according to claim 1, the terminal device further comprising:
a storage unit; and
an output unit, wherein:
the control unit is configured
to determine, as the processing for riding in the vehicle, whether an electronic ticket for riding in the vehicle is stored in the storage unit; and
to make the electronic ticket displayable through the output unit when the electronic ticket is determined to be stored in the storage unit.

5. The terminal device according to claim 4, wherein:
the electronic ticket is associated with information on a plurality of target vehicles in which the user can ride with the electronic ticket; and
the control unit is configured to determine that the electronic ticket for riding in the vehicle is stored in the storage unit when, based on the identification information on the vehicle, the vehicle is included in the target vehicles associated with the electronic ticket.

6. The terminal device according to claim 4, wherein:
the control unit is configured
to determine whether the electronic ticket is usage-start processed when the electronic ticket is determined to be stored in the storage unit; and
to perform usage-start processing to change the electronic ticket to a usage-start processed electronic ticket when the electronic ticket is determined not to be usage-start processed, the usage-start processing involving communication with a server.

7. The terminal device according to claim 4, wherein the control unit is configured to display a purchase screen of the electronic ticket via the output unit when the electronic ticket is determined not to be stored in the storage unit.

8. The terminal device according to claim 1, wherein the control unit is configured to determine that the user has got off the vehicle when the identification information on the vehicle is continuously received and then the reception of the identification information is ended.

9. A method performed by a terminal device including a control unit and a communication unit, the method comprising:
receiving identification information from a vehicle via short-range wireless communication through the communication unit, the identification information being able to identify the vehicle;
acquiring position information on the vehicle; and
performing processing for riding in the vehicle based on the identification information and the position information on the vehicle.

10. The method according to claim 9, the method further comprising determining that a user has ridden in the vehicle when the identification information on the vehicle is continuously received.

11. The method according to claim 9, wherein the acquiring the position information on the vehicle includes receiving the position information on the vehicle from the vehicle via the short-range wireless communication through the communication unit.

12. The method according to claim 9, wherein
the terminal device further includes:
a storage unit; and
an output unit, and
the method further includes:
determining, as the processing for riding in the vehicle, whether an electronic ticket for riding in the vehicle is stored in the storage unit; and
making the electronic ticket displayable through the output unit when the electronic ticket is determined to be stored in the storage unit.

13. The method according to claim 12, wherein:
the electronic ticket is associated with information on a plurality of target vehicles in which the user can ride with the electronic ticket; and
the determining whether the electronic ticket is stored includes determining, based on the identification information on the vehicle, whether the vehicle is included in the target vehicles associated with the electronic ticket.

14. The method according to claim 12, the method further comprising:
determining whether the electronic ticket is usage-start processed when the electronic ticket is determined to be stored in the storage unit; and
performing usage-start processing to change the electronic ticket to a usage-start processed electronic ticket when the electronic ticket is determined not to be usage-start processed, the usage-start processing involving communication with a server.

15. The method according to claim 12, the method further comprising displaying a purchase screen of the electronic ticket via the output unit when the electronic ticket is determined not to be stored in the storage unit.

16. The method according to claim 9, the method further comprising determining that the user has got off the vehicle when the identification information on the vehicle is continuously received and then the reception of the identification information is ended.

17. A non-transitory storage medium that stores a program causing a computer to perform:
receiving identification information from a vehicle via short-range wireless communication, the identification information being able to identify the vehicle;
acquiring position information on the vehicle; and
performing processing for riding in the vehicle based on the identification information and the position information on the vehicle.

18. The storage medium according to claim 17, wherein the program further causes the computer to determine that a user has ridden in the vehicle when the identification information on the vehicle is continuously received.

19. The storage medium according to claim 17, wherein the acquiring the position information on the vehicle includes receiving the position information on the vehicle from the vehicle via the short-range wireless communication.

20. The storage medium according to claim 17, wherein the program further causes the computer to perform:
determining, as the processing for riding in the vehicle, whether an electronic ticket for riding in the vehicle is stored; and
making the electronic ticket displayable when the electronic ticket is determined to be stored.
